(19) United States
(12) Patent Application Publication
(10) Pub. No.: US 2018/0198708 A1
(43) Pub. Date: Jul. 12, 2018

(54) DATA CENTER LINKING SYSTEM AND METHOD THEREFOR

(71) Applicant: Hitachi, Ltd., Tokyo (JP)

(72) Inventors: Sayuri ISHIKAWA, Tokyo (JP); Junji KINOSHITA, Tokyo (JP); Takahiro SAGARA, Tokyo (JP); Kazuhiro MAEDA, Tokyo (JP); Osamu TAKADA, Tokyo (JP)

(21) Appl. No.: 15/741,531

(22) PCT Filed: Jan. 13, 2016
(86) PCT No.: PCT/JP2016/050751

§ 371 Date: Jan. 3, 2018

(30) Foreign Application Priority Data
Jul. 24, 2015 (JP) PCT/JP2015/071054

(51) Int. Cl. H04L 12/741; H04L 12/46; H04L 12/66; H04L 29/08; H04L 29/06; G06F 9/455

(52) U.S. Cl. CPC H04L 45/74; H04L 12/4641; H04L 12/66; G06F 9/455; H04L 69/324; H04L 69/22; H04L 69/323

(57) ABSTRACT

The data center (DC) linking system provides a line under specified communication conditions to each tenant, wherein in each DC, a virtual network identifier (i) and/or (ii) serving as a communication type identifier which separates communications of each tenant of each of a plurality of DCs and a virtual network identifier (iii) which is provided by a carrier and serves as a line identifier which separates a plurality of communications having different communication conditions are identified and managed in association with each other; and the communications of each tenant are identified on the basis of the communication type identifier. Any one line identifier for allocating a line having a communication condition desired by a tenant is assigned to each communication identified on the basis of communication content in a transmitting side DC.

### TECHNICAL FIELD

The present invention relates to a technique of securing a condition of each of a plurality of communications performed with a base such as a data center (DC).

### BACKGROUND ART

In recent years, cloud computing or cloud services have been introduced into society, and movement of aggregating a wide variety of systems including corporate systems into a large-scale computer system called a DC has accelerated. The DC has equipment for stably operating a system, personnel distribution for it, a security function, and a robust facility that can withstand natural disasters.

Focusing on the system accommodated in the DC, a form of configuring one system in which a plurality of geographically dispersed DCs are linked (hereinafter referred to as a “DC linking system”) for a business continuity planning (BCP) request or edge computing (a form of providing a service from a data center geographically close to a user) is increasing.

Meanwhile, there is a public cloud as one of DC provision forms. The public cloud is characterized by a multi-tenant type in which a plurality of tenant systems are accommodated on one cloud system. Here, a term “tenant” refers to a logically distinguished set and corresponds to, for example, a company, a department, or the like. In other words, a plurality of tenant systems are accommodated in the DC.

Therefore, a DC service provider operates a plurality of tenant systems on a single DC linking system that links a plurality of DCs.

The DC service provider uses, for example, a virtual network for separation of communication of the multi-tenant system in the DC. In this specification, some of logical network resources which can be used by a certain user are referred to as a “virtual network.” Further, as techniques for implementing the virtual network, there are a virtual LAN (VLAN) and a technique described in Non-Patent Document 2.

Meanwhile, in order to implement the DC linking system, it is necessary for the DC service provider to cause a specific tenant system accommodated in a certain DC and a specific tenant system accommodated in a geographically separated DC to enter a state in which communication can be performed using a network owned by a communication carrier installed between the two DCs (a service provider that provides a rental service of a communication facility owned by the service provider in the form of a line contract (hereinafter referred to as a “carrier”). In other words, the DC service provider rents some of the network resources owned by the carrier. In this specification, some of the network resources rented from the carrier to a certain customer (the DC service provider in this example) are referred to as a “carrier line (or line).”

In the technique disclosed in Patent Document 1, a mobile virtual network operator (MVNO) recognizes a telephone terminal using a telephone number, an IP address, and a MAC address assigned to the telephone terminal serving as the endpoint, and allocates communication of the endpoint to the carrier line so that communication between the telephone terminal and a connection destination can be performed (Paragraphs [0002] and [0016]).

### CITATION LIST

### Patent Document

Patent Document 1: JP 2006-340267 A

### Non-Patent Document

Non-Patent Document 1: IEEE, “802.1ah-Provider Backbone Bridges,” [Searched on Jun. 3, 2015], Internet <URL: http://www.ieee802.org/1/pages/802.1ah.html>
Non-Patent Document 2: The Internet Engineering Task Force, “Virtual eXtensible Local Area Network (VXLAN): A Framework for Overlaying Virtualized Layer 2 Networks over Layer 3 Networks,” IETF, published on August, 2014], [Searched on Jan. 9, 2015], Internet <URL: https://datatracker.ietf.org/doc/rfc7348/>

### SUMMARY OF THE INVENTION

### Problems to be Solved by the Invention

In the multi-tenant system accommodated in the DC, there are cases in which a communication condition request to an inter-DC network differs in according to each tenant.

For example, a tenant A connects two DCs and constitutes a disaster recovery (DR) system of a backbone system, synchronization of difference data is performed in real time, and no delay is allowed. On the other hand, a tenant B performs a daily backup of e-mail data with two DCs, and it is sufficient that data can be synchronized within 24 hours.

In other words, for the tenant A, it is necessary to connect systems in a plurality of DCs under a communication condition requested by the tenant A, and for the tenant B, it is necessary to connect systems in a plurality of DCs under a communication condition requested by the tenant B. Here, a term “communication condition” refers to, for example, a quality of a line (for example, a low delay, a best effort, redundancy of a line, occupation or sharing of a physical line, or the like), security (encryption, a quarantine-enhanced network, or the like), or the like.

In other words, in the inter-DC network, it is necessary to separate communication on the basis of a condition different from that in the DC.

As described above, in the DC linking system, it is necessary to perform communication separation doubly.

On the other hand, duplexing of a virtual network (VLAN) is disclosed in Non-Patent Document 1.

However, in a technique disclosed in Non-Patent Document 1, the number of identifiers of the VLAN is an upper limit of the number of divisible communications. In other words, for example, there arises a problem in that the DC service provider is unable to accommodate 4094 or more tenants.

On the other hand, Non-Patent Document 2 discloses a technique (VXLAN) in which the number of virtual networks exceeds 4094 in the VLAN, that is, about 16 million virtual networks can be used.

In recent years, network devices supporting the VXLAN have been developed, and DCs having a configuration of supporting the use of the VXLAN as well have also increased. However, in this case, all devices in the DC are not necessarily compatible with VXLAN. The same applies to the carrier line.

In other words, the VLAN of the related art and the new VXLAN are used together in the DC and the carrier line. However, a technique of maintaining separation of communication in the DC or between DCs including the carrier line while using the VLAN and the VXLAN together is not implemented yet.

### Solutions to Problems

The disclosure relates to a technology of maintaining separation of end-to-end communication between a plurality of computer systems while using virtual network identifiers which are fewer in number than virtual network identifiers used in a computer system in a line connecting between the computer systems.

One specific aspect using the technology is a computer system linking system that connects a plurality of computer systems via a network.

As one more specific aspect of the disclosure, a DC linking system in which a plurality of DCs are connected by a carrier line under the assumption that a DC is a computer system will be described, and features thereof will be described with reference to FIG. 1.

The DC linking system has the following functions.

A function of identifying virtual network identifiers (i) and/or (ii) as serving as a communication type identifier of separating communication of each tenant of each of a plurality of DCs and a virtual network identifier (iii) serving as a line identifier of separating a plurality of communications having different communication conditions provided by a carrier and managing the virtual network identifiers in association with each other (a difference in use between the virtual network identifiers (i) and (ii) will be described later) in each DC.

A function of performing a setting in each communication device in a DC in order to realize communication using the virtual network identifiers (i) and/or (ii) and (iii) in each DC or instructing a setting.

A function of identifying communication of each tenant or a plurality of types of communications in each tenant on the basis of the virtual network identifiers (i) and/or (ii) in each DC.

A function of assigning any one carrier line identifier (the virtual network identifier (iii)) for allocating a carrier line having a communication condition desired by the tenant to each communication identified on the basis of communication content in a transmitting side DC. A function of identifying communication of each tenant or a plurality of types of communication in each tenant to which the carrier line identifier is assigned on the basis of the carrier line identifier and assigning the virtual network identifiers (i) and/or (ii) in a receiving side DC.

When a range in which separation is performed using a virtual network is smaller than a tenant (for example, a department in the tenant, a type or a purpose of communication, or an application), communication separated using the virtual network identifier (ii) may further be separated using the virtual network identifier (ii). In this case, an association between a combination of the virtual network identifiers (i) and (ii) and the virtual network identifier (iii) is managed.

The details of at least one embodiment of a subject matter disclosed in this specification are set forth in the accompanying drawings and the following description. Other features, aspects, and effects of the disclosed subject matter will be apparent from the following disclosure, drawings, and claims.

### Effects of the Invention

According to the disclosure, it is possible to allocate one of lines of a plurality of communication conditions while maintaining separation of communication in a connection between computer systems.

### BRIEF DESCRIPTION OF THE DRAWINGS

FIG. 1 is a diagram illustrating an overview of a disclosed process.

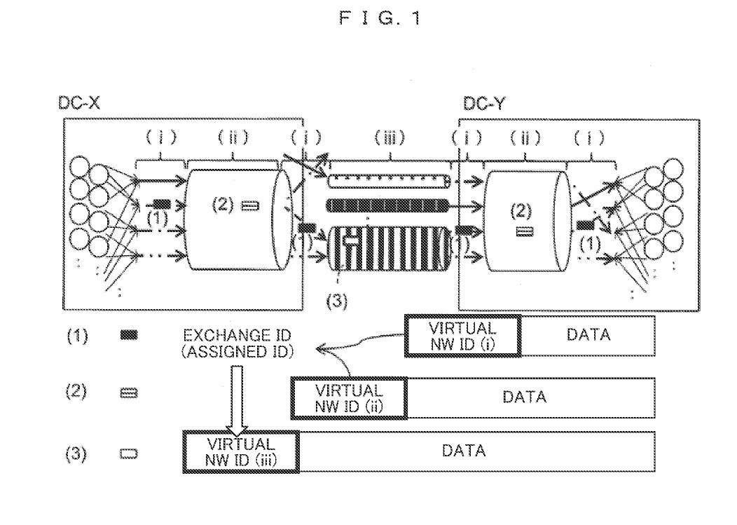

FIG. 2 is an overview of a configuration of a disclosed network system.

FIG. 3 is a diagram illustrating functional configurations of a physical machine 1, a virtual machine 2, a virtual switch 3, a virtual center edge 4, a VXLAN GW 5, a customer edge 6, a provider edge 7, and a management server 8.

FIG. 4 is a diagram illustrating an overview of a process of a VXLAN.

FIG. 5 is a diagram illustrating a processing flow of a carrier line connection system.

FIG. 6 is a diagram illustrating an identifier management table 3141.

FIG. 7 is a diagram illustrating a connection management table 3142.

FIG. 8A is a diagram illustrating a logical connection and the flow of a process in a DC-X according to an embodiment.

FIG. 8B is a diagram illustrating a logical connection and the flow of a process in a DC-Y according to an embodiment.

FIG. 9A is a diagram illustrating the flow of a process in a DC-X in a connection process according to an embodiment.

FIG. 9B is a diagram illustrating the flow of a process in a DC-Y in a connection process according to an embodiment.

FIG. 10 is a diagram illustrating a line management table 3143.

FIG. 11 is a diagram illustrating a carrier line connection setting interface screen.

FIG. 12 is a diagram illustrating an inter-DC connection applying interface screen.

### MODE FOR CARRYING OUT THE INVENTION

Hereinafter, an embodiment for solving the problem will be described.

The present embodiment will be described on the premise of the following situation.

The DC service provider operates a DC linking system that connects a plurality of DCs, and the DCs are connected using carrier lines having a plurality of different communication conditions provided by the carrier. For example, three types of (A) a best effort in which no delay is guaranteed, (B) a low delay (no redundancy), (C) a low delay (redundancy) are rented from the carrier.

The carrier line is a wide area line connection service provided by the carrier, and an MPLS, an IP VPN, a wide area Ethernet, or the like is used for the connection.

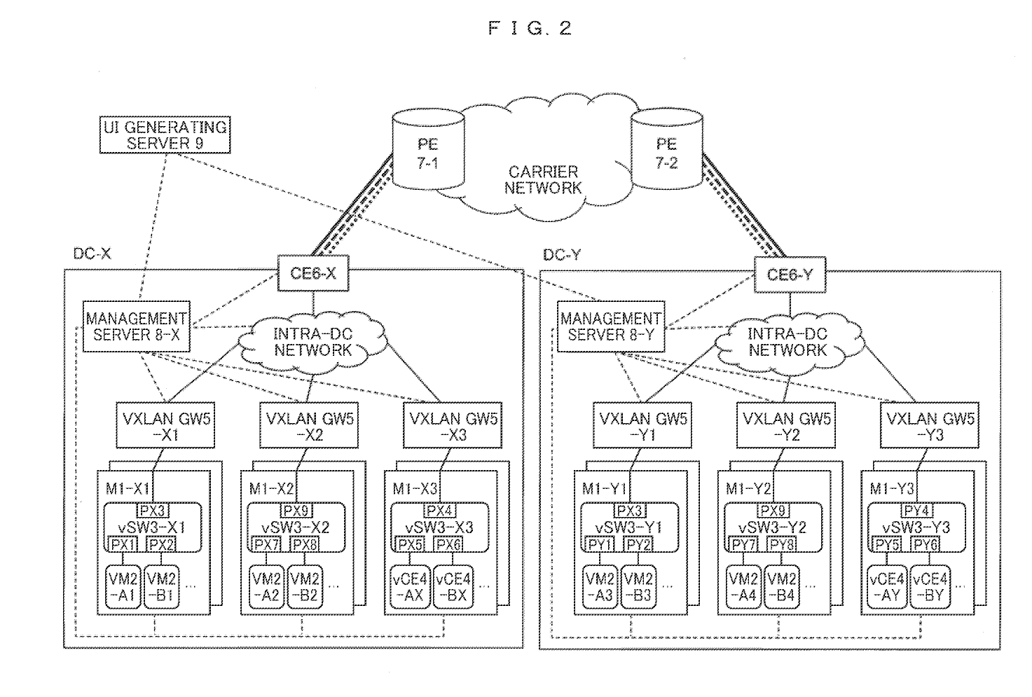

FIG. 2 is a configuration diagram illustrating the DC linking system that connects data centers DC-X and DC-Y via a carrier network in the present embodiment. The description will proceed while defining terms.

In each DC, a physical machine (hereinafter referred to as an “M”) 1 includes a virtual machine (hereinafter referred to as a “VM”) 2, a virtual switch (hereinafter referred to as a “vSW”) 3, and a virtual router called a virtual customer edge (hereinafter referred to as a “vCE”) 4. The virtual machine 2, the virtual switch 3, and the virtual router 4 are virtual devices implemented such that a program stored in a memory of the physical machine 1 is executed while using hardware resources of the physical machine 1.

In -A1, -B1, . . . , -AY, and -BY in FIG. 2, “A” and “B” are used to distinguish tenants, and 1 to Y are used to distinguish virtual machines within one tenant. In other words, FIG. 2 illustrates a multi-tenant environment in which VMs of different tenants are implemented on respective physical machines.

The “edge” of vCE 4 refers to a communication device located at the end of a management range. Since the tenant corresponds to a “customer” from a viewpoint of the DC service provider, a device positioned at an edge of a management range called a tenant is referred to as a “vCE.” The vCE is arranged for each tenant, and in the present embodiment, when the carrier line is used, it is necessary to go through the vCE. To this end, for example, there is a method of setting a default gateway of the VM of the tenant in the vCE 4. In the case of the present embodiment, the vCE 4 is under the control of the DC service provider, but since it is a communication device recognized by each tenant, for example, since the default gateway of the VM of the tenant is set in the vCE 4 as described above, it is called a vCE.

In FIG. 2, the vCE 4 is arranged in the M 1 that is physically different from the VM 2 but may be arranged in the same M 1 as the VM 2. A port Pn described in the vCE 4 will be described later.

The VM 2 and the vCE 4 are connected to the vSW 3, and the vSW 3 is connected to a physical router called a VXLAN gateway (hereinafter referred to as GW) 5. The GW is generally arranged at a boundary of a network and refers to a device that relays data between networks. In this specification, since the GW performs the relay while converting non-VXLN communication into VXLAN communication and vice versa using the VXLAN technique, it is referred to as a VXLAN GW.

In general, the VXLAN GW 5 is further connected to a plurality of switches, routers, or the like within the DC, but in the present embodiment, since a network configuration does not matter, it is referred to as an “intra-DC network.” As described above, there are cases where the number of identifiers is insufficient in the VLAN, and in each DC of the present embodiment, the VXLAN is used for the intra-DC network. Further, the VXLAN GW 5 may be virtually configured inside the physical machine 1.

The VXLAN GW 5 is connected to a physical router called a customer edge (hereinafter referred to as CE) 6 positioned at an entrance/exit of the DC via the network within the DC. The “customer” in the CE 6 is a DC service provider for the carrier, unlike the vCE 4. It is called a CE in the sense that it is positioned at an edge of a network managed by the DC service provider.

The CE 6 is connected to a physical router called a provider edge (hereinafter referred to as PE) 7 in a carrier network.

In the present embodiment, the CE 6 is connected to a carrier line that provides three types of different communication conditions. Here, the “provider” is a carrier. It is called a PE in the sense that it is positioned at an edge of a network managed by the carrier.

Further, a management server 8 is connected to the VM 2, the vSW 3, the vCE 4, the VXLAN GW 5, the CE 6, and a device of the intra-DC network. In the configuration illustrated in FIG. 2, the management server 8 is arranged for each DC but may be installed in any one DC. In this case, it is possible to collect information of devices of other DCs and to give an instruction such as a setting or the like to the vCE 4, the VXLAN GW 5, or the like arranged in each DC.

A user interface (hereinafter referred to as a “UI”) generating server 9 provides a UI to a user or an administrator such as the DC service provider, the tenant, or the like. The UI generating server 9 is connected with the management server 8 via a network such as the carrier network.

The configuration described above is merely an example, and the present invention is not limited thereto. For example, the virtual switch may be a physical switch, a virtual router, or a physical router. Further, the DC linking system may be configured to have three or more DCs. In this case, the CEs 6 arranged in a plurality of DCs may be connected to the same PE 7 or may be connected to a new PEn (not illustrated) (n is a natural number other than 1 and 2). In the latter case, it is assumed that communication is possible among three or more PEs in any combination, and the carrier line providing a plurality of different communication conditions is provided.

Further, in the present embodiment, a device that operates in a layer 2, that is, a device that performs communication conforming to an Ethernet (a registered trademark) standard specified in IEEE 802.3 is referred to a “switch,” and a device that operates in a layer 3, that is, a device that performs communication conforming to an IP standard specified in IETF RFC 791 is referred to a “router.” A functional difference lies in that the router decides an output port with reference to a MAC address of a packet, and the router decides an output port with reference to an IP address. (The packet refers to an individual chunk after division when data is divided and transmitted via a network.) At this time, the output port is decided with reference to an address table 310 to be described later. The address table 310 used in the present embodiment collectively refers to tables used in the layer 2 and the layer 3.

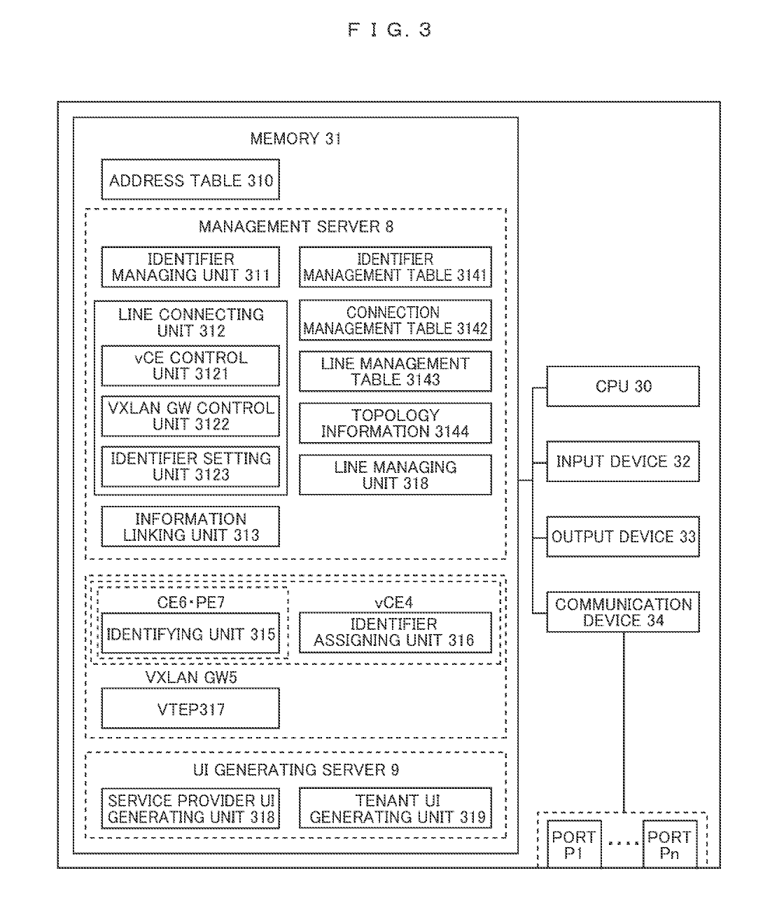

FIG. 3 is a diagram illustrating hardware and software configurations of the devices (the M 1, the VM 2, the vSW 3, the vCE 4, the VXLAN GW 5, the CE 6, the PE 7, and the management server 8) described with reference to FIG. 2.

Each of the devices includes a CPU 30, a memory 31, an input device 32, an output device 33, a communication device 34, and one or more ports Pn (n is a natural number) which are connected via an internal bus.

A program being executed or data is recorded in the memory 31. A program or data in each device may be stored in the memory 31 in advance or may be stored in a storage device similarly connected via the internal bus although not illustrated, and for example, a program or data may be input from an external medium such as an SD memory card or a CD-ROM. Further, functions implemented by a program may be implemented by dedicated hardware.

The input device 32 is, for example, a device that inputs an instruction of the user from a mouse or a keyboard, and the output device 33 is a device that causes a state of the input or a result of a process executed on the memory 31 to be output a management screen or the like.

The communication device 34 is a device that performs transmission and reception of packets with other devices via the port Pn. The CPU 30 executes the program stored in the memory 31.

Next, functions executed in the memory 31 will be described.

First, the address table 310 is commonly stored in all the devices. The device outputs a packet through the port Pn registered for each destination address with reference to the address table 310.

Next, functions of the management server 8 will be described. An identifier managing unit 311 acquires information such as a virtual network identifier or a carrier line identifier from, for example, the VM 2, the vSW 3, the vCE 4 (actually the M 1), the VXLAN GW 5, the CE 6, the management server 8, or a management system managing them or by manual input or the like and register the acquired information in an identifier management table 3141.

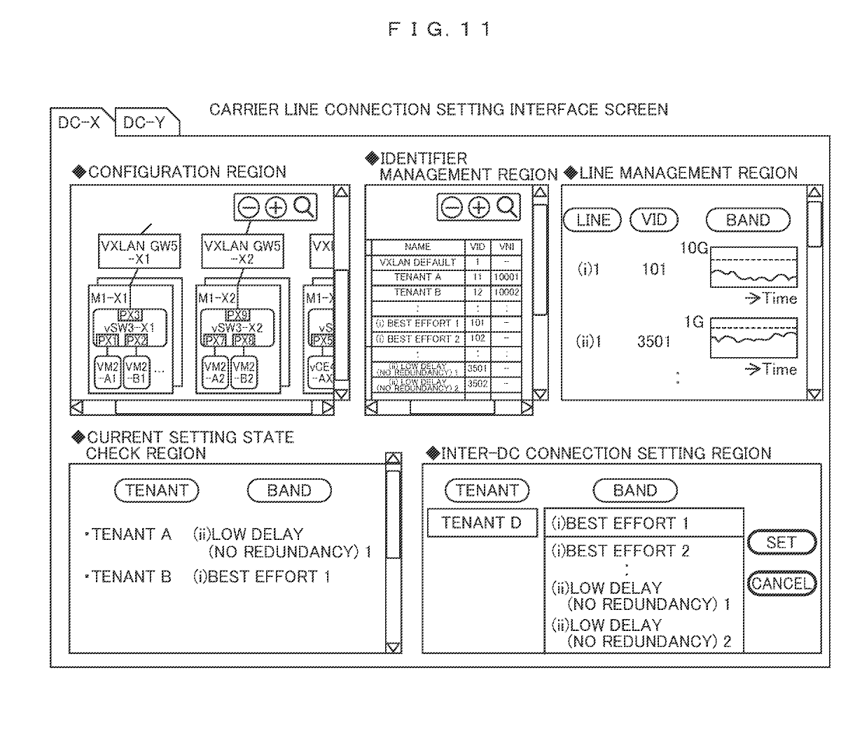

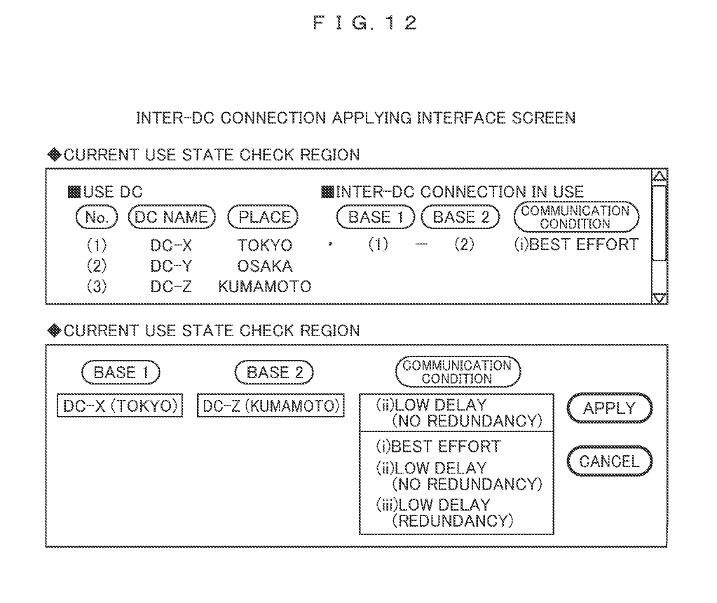

Next, functions of the UI generating server 9 will be described. In the present embodiment, a service provider UI generating unit 318 provides a carrier line connection setting interface screen (for example, FIG. 11) used when the DC service provider performs a setting for connecting the communication of the tenant in the DC with the carrier line. In the present embodiment, a tenant UI generating unit 319 provides an inter-DC connection applying interface screen (for example, FIG. 12) used when the tenant applies for a network connection between VMs between bases and designates a communication condition desired by the user.

In the present embodiment, the communication of the tenant is distinguished using the virtual network identifier, but as information corresponding to the virtual network identifier, an IP address, a MAC address, or the like may be used. In other words, information other than the virtual network identifier can be used as long as the communication of the tenant can be distinguished.

A line connecting unit 312 performs a process of connecting the communication of the tenant with the carrier line of the communication condition desired by the tenant while generating a connection management table 3142 and issuing a setting or a command of a vCE control unit 3121 and a VXLAN GW control unit 3122. Further, an information linking unit 313 exchanges information of the connection management table 3142 with the management server 8 of another DC.

A line management unit 318 measures a band using the carrier line or a band actually flowing in the carrier line to a contract for each contract of the tenant and records values thereof in a line management table 3143.

Next, functions of the CE 6 and the PE 7 will be described. An identifying unit 315 acquires an identifier included in a packet and executes a different process for each identifier. For example, it is possible to cause the address table 310 to be referred to be different for each identifier or change a communication quality for transmitting a packet for each identifier.

In addition, the vCE 4 includes an identifier assigning unit 316 and assigns an identifier in a packet.

In addition, the VXLAN GW 5 includes a VXLAN tunnel end point (VTEP) 317 and performs encapsulation by the VXLAN.

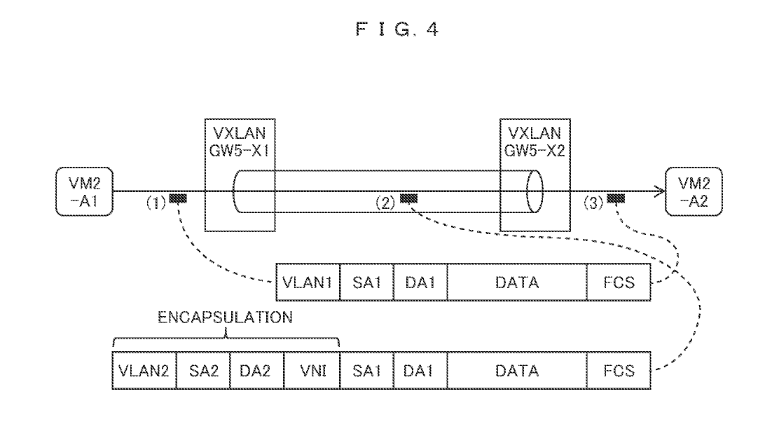

An overview of an encapsulation process performed by the VXLAN will be described with reference to FIGS. 2 and 4.

A case in which a VM 2-A1 illustrated in FIG. 2 transmits a packet to a VM 2-A2. In the present embodiment, since the multi-tenant environment is implemented in the M 1, the VLAN is assumed to be used for separation of the inter-tenant communication in an M1-X1 in which the VM 2-A1 is accommodated.

A packet transmitted by VM 2-A1 arrives a VXLAN 5-X1 via a vSW 3-X1, and the encapsulation process is here performed by the VXLAN. As illustrated in FIG. 4, an original packet (1) is encapsulated by a VTEP 317 of a VXLAN GW 5-X1, a VXLAN network identifier (VNI), DA2 (a destination address) and SA2 (a source address) of the VTEP 317, a VLAN2 (a virtual local area network), and the like are added (2), and an encapsulated part is removed by a VXLAN GW 5-X2 again, and an original VLAN1 is added.

In the present embodiment, a default VLAN ID1 is assumed to be assigned to a VLAN2 encapsulated by the VXLAN GW 5.

The packet encapsulated by the VXLAN flows in the intra-DC network. The VTEP 317 can distinguish the tenant using the VNI added by the VTEP 317, but since the CE 6 and the PE 7 do not support the VXLAN, the CE 6 and the PE 7 are unlikely to identify the communication of the tenant. Therefore, when the carrier line is used for the connection between DCs, a carrier line of a different communication condition is unable to be selected for each tenant.

According to the present embodiment, it is possible to select a carrier line of any one communication condition from among carrier lines of a plurality of communication conditions in connection between DCs for each tenant or for each type of communication in the tenant.

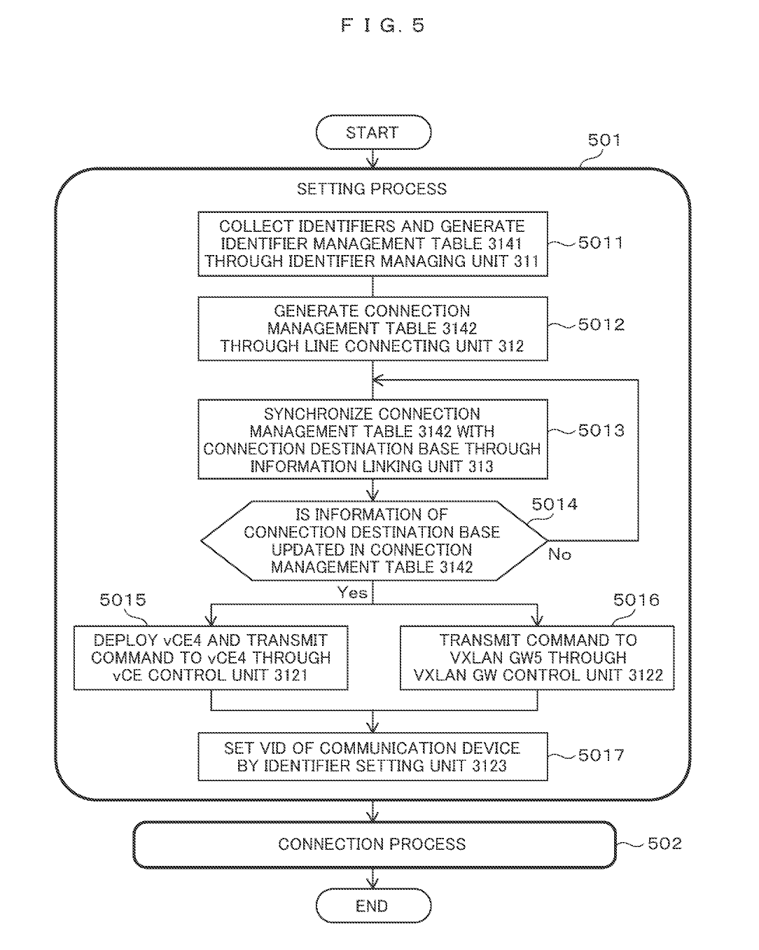

A detailed description will proceed below with reference to FIGS. 5 to 9.

A VM 2-A1 of the tenant A and a VM 2-B1 of the tenant B are accommodated in the DC-X, and as described above, each tenant desires to establish a connection with the VM of its own tenant in the DC-Y. At this time, it is assumed that the communication condition of the carrier line requested by the tenant A is (B) the low delay (no redundancy), and the communication condition of the carrier line requested by the tenant B is (A) the best effort.

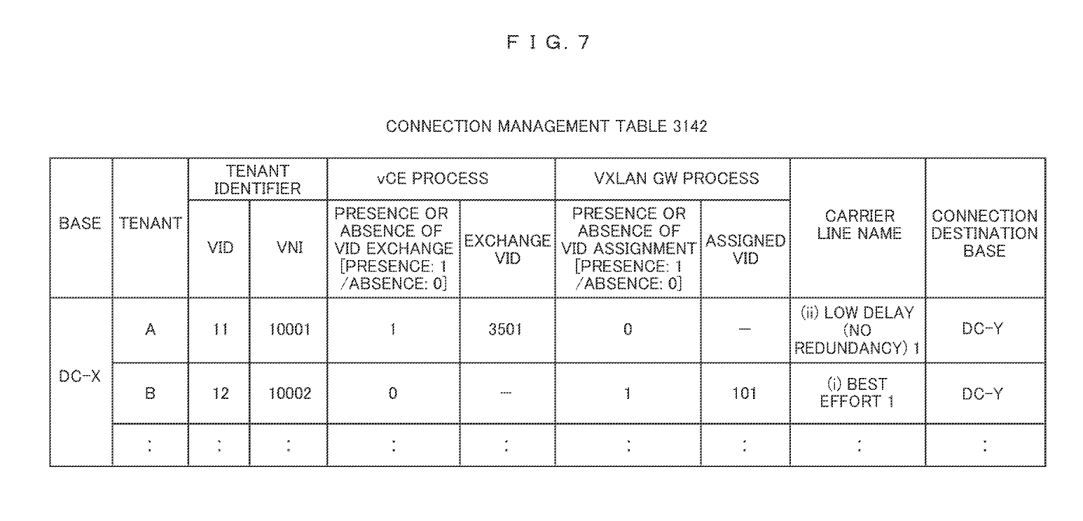

As a method of establishing a connection with a different carrier line in the DC, for example, a VLAN ID (VID) is used. In other words, the CE 6 connected to the carrier line changes the carrier line to be connected for each VID. For example, as illustrated in FIG. 7, the CE 6 transmits a packet to which a VID “3501” is assigned to the carrier line of (B) the low delay (no redundancy), and transmits a packet to which a VID “101” is assigned to the carrier line of (A) the best effort.

FIG. 5 illustrates the flow when a connection with a different carrier line is established in the DC.

Roughly, a setting process (501) performed by the management server 8 is executed, and then a connection process (502) performed by the vCE 4 and the VXLAN GW 5 is executed. The setting process is preferable executed once. The connection process is executed each time a packet flows after the setting process is executed.

The setting process (501) will be first described.

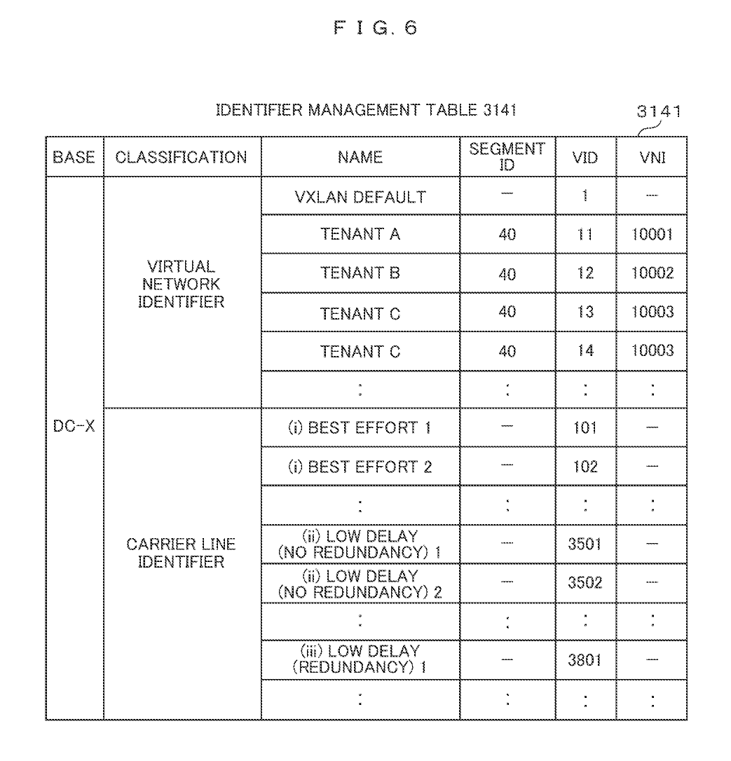

First, the identifier managing unit 311 collects identifiers used in the DC and generates the identifier management table 3141 (5011). Specifically, as illustrated in FIG. 6, information specifying the DC, a segment ID, a VID which is used in intra-DC network and assigned by default after the VXLAN encapsulation, and a VID and a VNI allocated to the tenant as the virtual network identifier are associated. At the same time, information of the VID allocated to each carrier line having a different communication quality is recorded as the carrier line identifier, and it is checked whether or not there is duplication with the virtual network identifier. However, in the above example, it is assumed that the VLAN is used for separation of communication in the M1, and the VXLAN is used for separation of communication between the M1 and the M1.

Regarding the segment ID, since duplication of other IDs (VIDs, VNIs, or the like) is allowed for each segment, for example, if the segment ID is different, it is identified as a different communication even though the VID is the same. For example, in the case of the VLAN, since an upper limit of the number of IDs is 4094 and not large, there is a problem in that that the number of tenants exceeding the upper limit is unable to be accommodated. On the other hand, if a segment ID is given, and duplication of a VID is distinguished with a difference in a segment ID, more tenants can be accommodated.

When a minimum range in which the separation is performed using the virtual network is a tenant, the VID and the VNI correspond to each other in a one-to-one manner as illustrated in FIG. 6. When the range in which the separation is performed using the virtual network is finer than the tenant (for example, a department in the tenant, a type or a purpose of communication, or an application), the separation is performed for each range using a virtual network such as the VLAN. In this case, the identifier (for example, the VID of the VLAN) used for the separation in the tenant and the identifier (for example, the VNI of VXLAN) used for the separation between the tenants do not correspond to each other in a one-to-one manner, and, for example, one or more VIDs correspond to the VNI assigned to each tenant as in a tenant C illustrated in FIG. 6.

Then, the line connecting unit 312 generates the connection management table 3142 (5012). Specifically, in the generation of the connection management table 3142, a designated line identifier (an exchange VID or an assigned VID) is assigned for each tenant in which separation is performed or for each type or purpose of communication in each DC as illustrated in FIG. 7.

The process of assigning the exchange VID may be performed in the vCE 4 or may be performed in the VXLAN GW 5.

As described above, when the minimum range in which the separation is performed using the virtual network is smaller than the tenant, that is, when one or more VIDs correspond to the VNI assigned to each tenant, the exchange VID is decided depending on a combination of the VNI and the VID.

In the case of the present embodiment, since the number of exchange VIDs is less than or equal to the number of types of line, one or more VNIs correspond to one exchange VID regardless of the range in which the separation is performed using the virtual network. If the communication separation minimum range is smaller than the tenant, one or more VIDs further correspond to one VNI. In other words, in the case of the present embodiment, communication separated by L VIDs and M VNIs is aggregated into N VIDs.

The information linking unit 313 transmits the information of the connection management table 3142 to the management server 8-Y of the DC-Y indicated in the connection destination base in order to exchange it with another DC (5013). Further, an information transmission request is issued to the connection destination base, and the information linking unit 313 stores the information of the connection management table 3142 received from the connection destination base in the connection management table 3142 managed by the information linking unit 313.

When the information of the same tenant in the connection destination base is updated in the connection management table 3142 (5014), the information linking unit 313 executes a process indicated by 5015 and 5016. When the information of the connection destination base is not updated even after a certain period of time elapses (5014), the process returns to the process of 5013.

In the present system, when the information of the connection management table 3142 is received from a connection destination DC, a preparation for performing the connection process is regarded as being completed in the connection destination DC, and a process subsequent to 5015 is executed.

The vCE control unit 3121 deploys the vCE 4 and transmits a command to the vCE 4 (5015). Specifically, the vCE control unit 3121 deploys the vCE 4 for the tenant A that performs a process of exchanging the VID of the packet from 11 to 3501 when the tenant A is registered as the presence in the VID exchange process in the vCE 4 with reference to a vCE processing filed of the connection management table 3142. When the absence is registered in the VID exchange process in the vCE 4 as in the tenant B, the process of exchanging the VID of the packet is not performed in the vCE 4.

The VXLAN GW control unit 3122 transmits a command to the VXLAN GW 5 (5016). Specifically, the VXLAN GW control unit 3122 performs a setting in the VXLAN GW 5 so that the process of assigning the VID 101 to the packet is performed when the tenant B is registered as the presence in the VID assignment process in the VXLAN GW with reference to a VXLAN GW processing filed of the connection management table 3142. When the absence is registered in the VID assignment process in the VXLAN GW 5 as in the tenant A, the process of assigning the VID of the packet is not performed in the VXLAN GW 5.

The order of 5015 and 5016 does not matter.

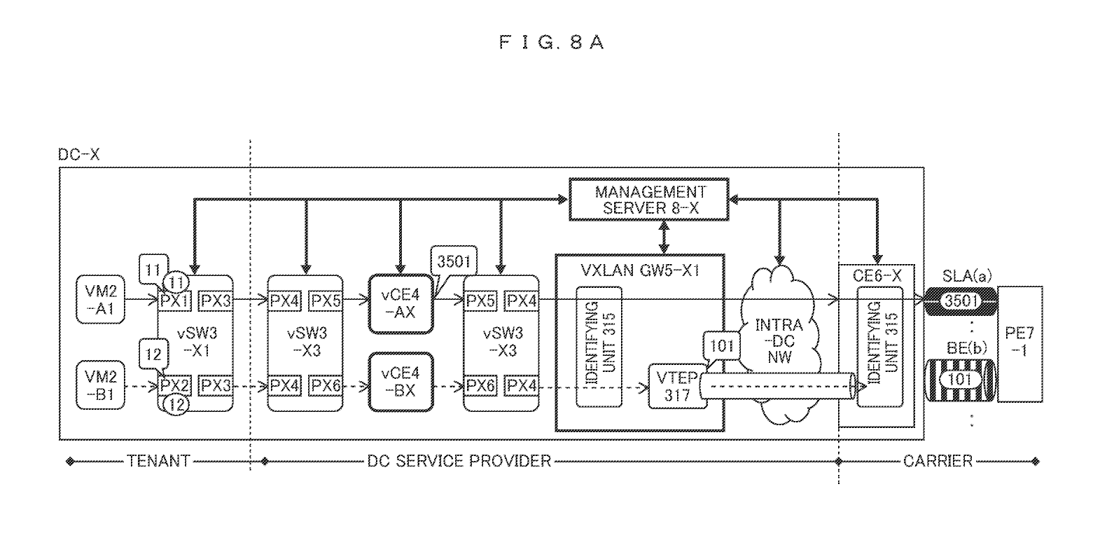

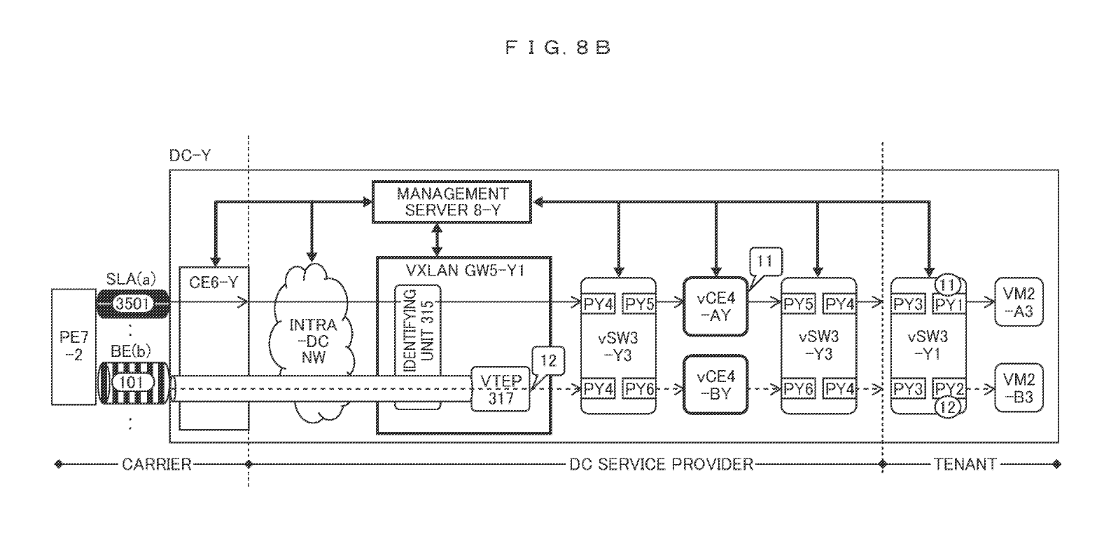

Then, an identifier setting unit 3123 sets the VID of the communication device such as the vSW 3 and the VXLAN GW 5 (5017). This process will be described with reference to FIG. 8.

FIG. 8 is a diagram illustrating a logical connection and the flow of a process of the carrier line connection system.

In the present embodiment, a method in which a setting is performed in the vCE 4 for the connection with the carrier line of (B) the low delay (no redundancy) and performed in the VXLAN GW 5 for the connection with the carrier line of (A) the best effort is described.

In the present system, it is necessary to align a VID of a communication device arranged in a path until a packet transmitted from the VM of the tenant arrives at the CE 6 so that the communication of the tenant is connected with the carrier line. In other words, the identifier setting unit 3122 sets the VLAN of the communication device such as the vSW 3 and the VXLAN GW with reference to the connection management table 3142 and topology information 3144.

For example, as a setting of enabling communication from the VM 2-A1 to the VM 2-A3 for the tenant A, a trunk VLAN of the VID 3501 is set in a port PX4, trunk VLANs of the VIDs 11 and 3051 are set in a port PX5, and a trunk VLAN of the VID 3501 is similarly set in a port Pn of a communication device in a path from a vSW 3-X3 to a CE 6-X in the DC-X.

Further, it is necessary to set the trunk VLAN of the VID 3501 in the port Pn of the communication device in the path from a CE 6-Y to a port PY4 of a vSW 3-Y3 in the DC-Y.

On the other hand, as a setting to enable communication from the VM 2-B1 to a VM 2-B3 for the tenant B, a trunk VLAN of a VID 12 is set in a port PX6. Then, the trunk VLAN of the VID 101 is set in the port Pn of the communication device in the path from the VXLAN GW 5-X1 to the CE 6-X.

Further, it is necessary to set the trunk VLAN of the VID 101 in the port Pn of the communication device in the path from the CE 6-Y to the VXLAN GW 5-Y1 in the DC-Y, but this setting is performed in the DC-Y.

The setting process of the identifier setting unit 3123 for the communication from the VM 2 of the DC-X to the VM 2 of the DC-Y has been described above, but a similar setting process is performed for the communication from the DC-Y to the DC-X.

The above example is the flow of the setting process performed by the management server 8.

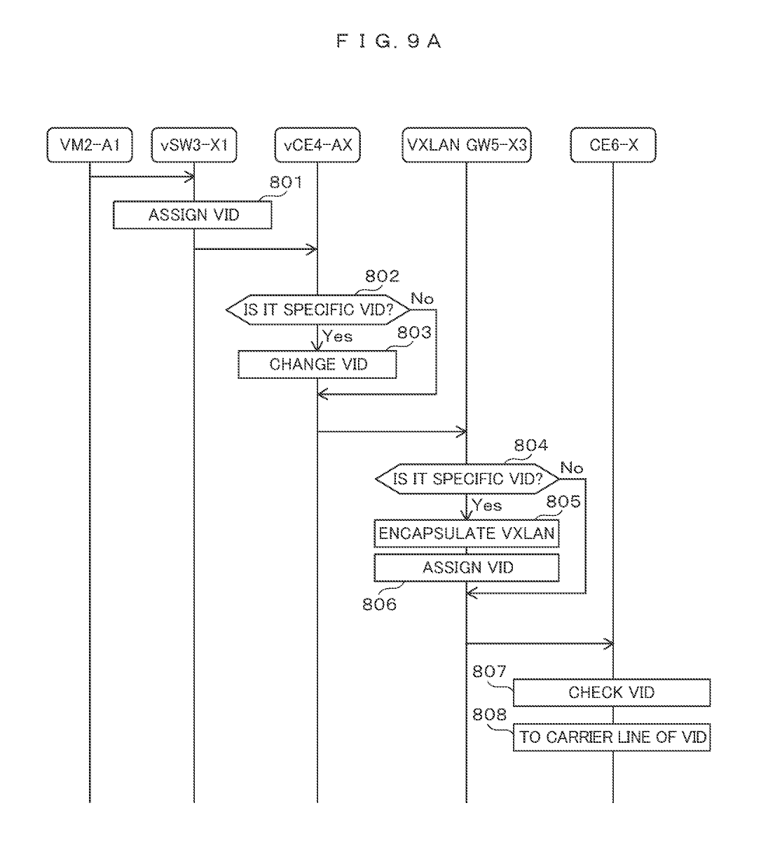

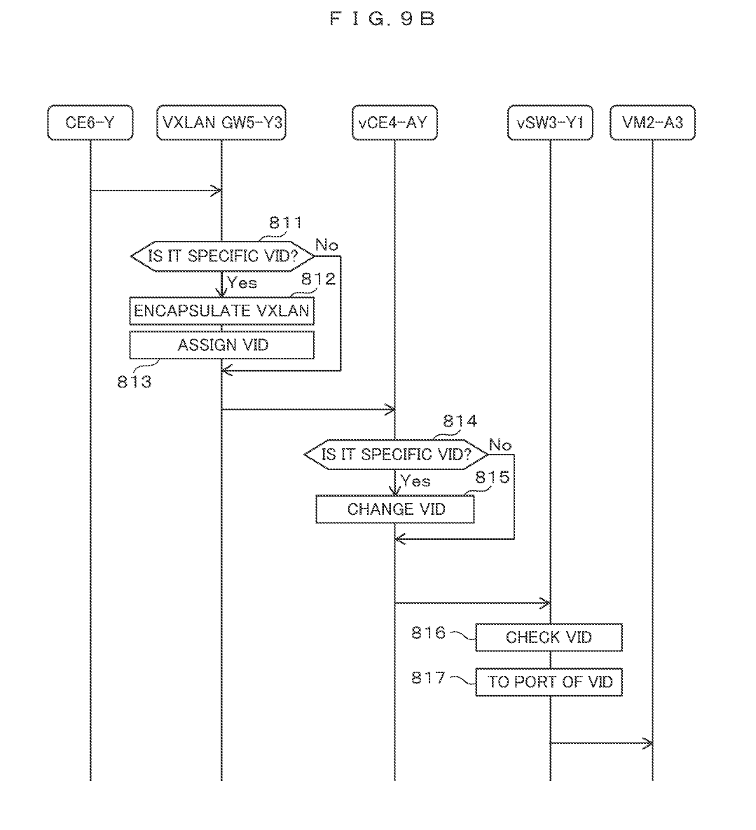

Next, the flow of the connection process (502) will be described above with reference to FIGS. 8 and 9.

The process in the DC-X will be described with reference to FIGS. 8A and 9A.

First, a case in which the VM 2-A1 of the tenant A of the DC-X transmits a packet to the VM 2-A3 of the DC-Y (see FIG. 2) is considered.

The VM 2-A1 transmits the packet. At this time, the packet communication process is the flow in which the communication device 34 transmits the packet to the destination port Pn with reference to the address table 310 as described above, and description thereof is here omitted. The vSW 3-X1 receives the packet through the port PX1, and the communication device 34 assigns the VID 11 set in an access VLAN of the port PX1 (801) and transmits the packet.

In the packet, VID change (exchange) or assignment is performed on a specific VID in the vCE 4-AX or the VXLAN GW 5-X3. The “specific” is decided for each communication condition of the carrier line selected by the tenant. In the present embodiment, the VID change (exchange) or assignment is performed in the vCE 4 or the VXLAN GW 5 for load distribution. Specifically, since the vCE 4 performs the change (exchange) process for communication in which the communication condition of the low delay is selected, the VID becomes a “specific VID,” and since the VXLAN GW 5 performs the assignment process for communication in which the communication condition of the best effort delay is selected, the VID becomes a “specific VID.”

The vCE 4-AX receives the packet, the identifying unit 315 checks the VID assigned to the packet, and when the VID is the specific VID 11 (802), the VID is changed to the VID 3501 (803), and the packet is transmitted.

The VXLAN GW 5-X3 receives the packet, and the identifying unit 315 checks the VID attached to the packet and transmits the packet without performing a process of 805 and 806 since the VID is not a specific VID (804). The CE 6-X receives the packet, and the identifying unit 315 refers to the VID assigned to the packet (807) and transmits the packet to the carrier line SLA(a) of the low delay allocated to the VID 3501 (808).

The specific VIDs identified by the vCE 4 and the VXLAN GW 5 are VIDs which the vCE control unit 3121 of the management server 8 previously sets in the vCE. The management server 8 gives an instruction to determine whether or not the VID is replaced on the basis of the VID assigned to the packet with reference to the connection management table 3142 to the vCE 4 and the VXLAN GW 5, and gives an instruction to change the VID to the exchange VID described in the same table when there is a VID exchange request.

In the above example, the packet of the tenant A is transmitted to the outside of the DC without being encapsulated by the VXLAN GW 5. It is merely a difference in an embodiment whether or not the encapsulation is performed, and the encapsulation may be performed as in step 803 to be described later.

A process in the DC-Y will be described with reference to FIGS. 8B and 9B.

The CE 6-Y receives the packet from the carrier network and transmits the packet to the network in the DC-Y. A VXLAN GW 5-Y3 receives the packet, and the identifying unit 315 checks the VID assigned to the packet and transmits the packet without performing a process of 812 and 813 since the VID is not a specific VID (811). The vCE 4-AX receives the packet, and the identifying unit 315 checks the VID assigned to the packet, and when the VID is a specific VID 3501 (814), the identifying unit 315 changes the VID to the VID 11 (815) and transmits the packet. A vSW 3-Y1 receives the packet, and the identifying unit 315 refers to the VID assigned to the packet (816) and transmits the packet to the port PY 1 to which the VID 11 is allocated (817).

Next, a case in which the VM 2-B1 of the tenant B in the DC-X transmits a packet to the VM 2-B3 in the DC-Y (see FIG. 2) is considered.

A process in the DC-X will be described with reference to FIGS. 8A and 9A. Here, the VM 2-A1 and the vCE 4-AX are replaced with the VM 2-B1 and the vCE 4-BX.

The VM 2-B1 transmits a packet. The vSW 3-X1 receives the packet through the port PX 3, the communication device 34 assigns the VID 12 set in the access VLAN of the PX 3 (801) and transmits the packet. The vCE 4-BX receives the packet, and the identifying unit 315 checks the VID assigned to the packet and transmits the packet without performing a process of 803 since the VID is not a specific VID (802).

The VXLAN GW 5-X3 receives the packet, and the identifying unit 315 checks the VID assigned to the packet, and when the VID is the specific VID 12 (804), the identifying unit 315 transfers the packet to the VTEP 317, and the VTEP 317 assigns a VNI 10002 identifying the tenant B after the VXLAN encapsulation (805), further assigns the VID 101 to the encapsulated packet (806), and transmits the packet.

The identifying of the specific VID in the VXLAN GW 5 is one which the VXLAN GW control unit 3122 of the management server 8 previously set in the VXLAN GW 5.

The CE 6-X receives the packet, and the identifying unit 315 refers to the VID assigned to the packet (807), and transmits the packet to the carrier line BE(b) of the low delay assigned to the VID 101 (808).

A process in the DC-Y will be described with reference to FIGS. 8B and 9B. Here, the vCE 4-AY and the VM2-A3 are replaced with the vCE 4-BX and the VM2-B3.

The CE 6-Y receives the packet from the carrier network and transmits the packet to the network in the DC-Y. The VXLAN GW 5-Y3 receives the packet, and the identifying unit 315 checks the VID assigned to the packet, and when the VID is a specific VID 12 (811), the identifying unit 315 transfers the packet to the VTEP 317, and the VTEP 317 assigns a VNI 10002 identifying the tenant B after the VXLAN encapsulation (812), further assigns the VID 101 to the encapsulated packet (813), and transmits the packet. The vCE 4-BX receives the packet, and the identifying unit 315 checks the VID assigned to the packet and transmits the packet without performing a process of 815 since the VID is not a specific VID (814). The vSW 3-Y1 receives the packet, and the identifying unit 315 refers to the VID assigned to the packet (816) and transmits the packet to the port PY 2 to which the VID 12 is allocated (817).

In the present embodiment, each packet passes through the vCE 4 and the VXLAN GW 5, and each device determines whether or not the packet is a processing target of its own device. As another method, the vSW 3-X1 may determine the VID after the VID is assigned (801) and transmit the packet to the vCE 4 or the VXLAN GW 5 for each ID, and in this case, the determination process of the vCE 4 or the VXLAN GW 5 may be omitted. In this case, the vCE 4-AX transmits the packet to the CE 6-X. Further, in the receiving side DC, similarly, the CE 6-Y may determine the VID and transmit the packet to the vCE 4 or the VXLAN GW 5 for each ID.

Through the process performed by the carrier line connection system described above, it is possible to select a carrier line of a communication condition desired by the tenant from among carrier lines of a plurality of carrier condition for each tenant. In other words, the tenant A can be connected to the carrier line of (B) the low delay (no redundancy), and the tenant B can be connected to the carrier line of (A) the best effort.

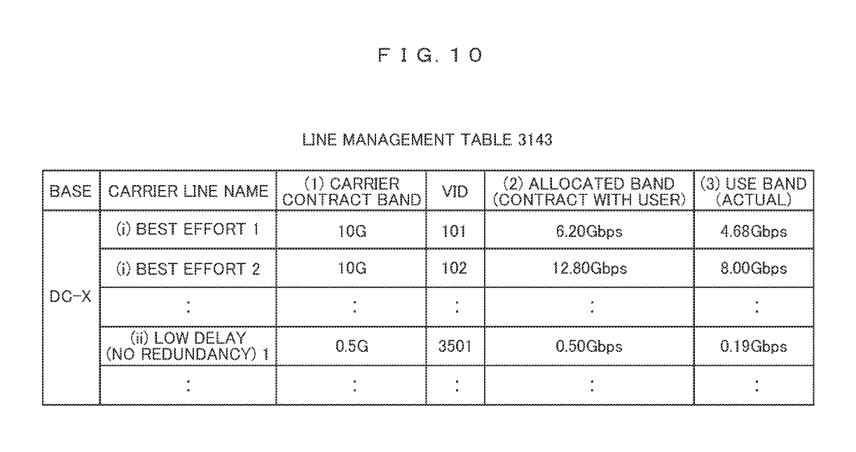

FIG. 10 is a table illustrating monitoring of a use state of the carrier line performed by the line management unit 318 of the management server 8.

As shown in the line management table 3143, the line management unit 318 manages (1) a band of the carrier line contracted from the carrier and an identifier VID identifying the carrier line, (2) a state of an allocated band (a band of a carrier line allocated on the basis of a contract with a tenant), and (3) a measured actual use band.

The measurement may be performed in a form in which values measured at regular time intervals are rewritten using a known technique such as SNMP or sFlow or may be performed in a form in which a history of measured values is also recorded as temporal data.

For example, in the case of the state of the carrier line BE(b), (1) the carrier contract band is 10 Gbps, (2) the allocated band is 6.20 Gbps, and (3) the use band is 4.68 Gbps. In this case, since there is a margin in a line, for example, when a tenant desiring (A) the best effort appears newly, it may be added to the line. It can be used as a criterion of deciding the tenant number to be accommodated in the carrier line with reference to (2) the allocated band and (3) the use band of the present table.

Further, it is possible to decide the number of tenants to be accommodated in one carrier line freely. When many tenants are accommodated in one carrier line, it affects the communication quality. For example, for example, in a carrier line of (A) best effort 2, (1) the carrier contract band is 10 Gbps, (2) the allocated band is 12.80 Gbps, and the allocated band (2) exceeds the carrier contract band (1), but an actually used band is (3) 8.00 Gbps, and thus in the carrier line BE(c), the communication can be performed in a state in which no congestion occurs. For example, in the carrier line connection system, a threshold value (for example, 9 Gbps) is set in (3) the use band using a value smaller than (1) the carrier contract band using the line management table 3143 effectively, and when (3) the use band exceeds than the threshold value, it is possible to incorporate, for example, a process of giving an alert so that no tenant is not allocated to the carrier line later.

FIG. 11 is a diagram illustrating the carrier line connection setting interface screen. This is provided by the service provider UI generating unit 318 of the UI generating server 9. The interface screen is an interface that the DC service provider prepares for itself, and the operator of the DC service provider uses the interface screen in order to connect the communication of the tenant to the carrier line using the carrier line connection system.

The interface screen includes a system configuration region, an identifier management region, a line management region, a current setting state check region, and an inter-DC connection setting region for each DC.

Connection relations of machines managed by the DC service provider such as the VM 2, the vSW 3, and the VXLAN GW 5 are indicated in the system configuration region.

The identifier illustrated in FIG. 6 is displayed in the identifier management region, and for example, when an arbitrary identifier is clicked in the identifier management region, values of a device and an identifier set in the configuration region may be displayed.

(1) The carrier contract band, (2) the allocated band, and (3) the use band for each carrier line illustrated in FIG. 10 are displayed in the line management region. The display may have either or both of a graph form or a numerical form as illustrated in FIG. 11 or may have a form in which temporal data can be displayed or a form in which it is possible to refer to previous data which is not displayed as illustrated in FIG. 11.

A tenant currently connected to the carrier line in the DC and the communication condition of the carrier line are indicated in the current setting state check region.

When there is an application regarding inter-DC connection from a tenant receives, the inter-DC connection setting region becomes a setting area for connecting the communication of the tenant with a carrier line having a desired communication condition. For example, the operator pulls down and selects the tenant that has applied from among the tenants accommodated in the DC and selects the carrier line desired by the tenant, and when a set button is pushed down, the carrier line connection system linked with the present interface performs a connection setting. For example, the above-described “specific VID” of the carrier line differs between the communication condition of the “best effort” and the communication condition of the “low delay,” and different conditional bifurcation results are obtained in step 802 and step 804.

In the selection of the carrier line, for example, it is also possible to select a vacant carrier line with reference to (3) the use band illustrated in FIG. 10. Further, newly set information is reflected in the current setting state check region. Further, a cancellation setting may be performed through the present interface screen.

FIG. 12 is a diagram illustrating an example of the inter-DC connection applying interface screen. This is provided by the tenant UI generating unit 319 of the UI generating server 9. This is an interface which the DC service provider prepares for the tenant whose system is accommodated in the DC. The operator of the tenant uses the communication of the tenant in order to establish a connection with a certain carrier line in accordance with the communication condition selected by the tenant.

The interface screen includes a current use state check region and an inter-DC connection use applying region. For example, the user of the tenant can access a tenant-dedicated interface screen by accessing a URL provided from the DC service provider and inputting an ID and a password for a tenant assigned from the DC service provider.

A DC in which the system of the tenant is accommodate, bases which enter a mutually connectable state in accordance with the application of the tenant, and a communication condition of a carrier line connecting the bases are displayed in the current use state check region. In the inter-DC connection use applying region, when the tenant desires that communication is performed between the systems accommodated in two or more DCs, an application for connecting the DCs by a carrier line is performed.

For example, the user pulls down, selects two bases which are desired to be connected and a communication condition of a carrier line connecting the two bases, and pushes an apply button, application information is transmitted to the DC service provider. A form of the transmission may be displayed on the inter-DC connection applying interface screen illustrated in FIG. 11 in a pop-up form, an e-mail form, or the like. Further, a setting may be performed automatically after the present application is made in cooperation with the carrier line connection system. Similarly, the application may be canceled through the present interface screen.

The interface screens illustrated in FIGS. 11 and 12 are merely examples, all the elements need not be necessarily provided as long as a necessary process can be performed, and other elements may be included.

In the present embodiment, the example in which the management server 8 changes the VID of the packet in cooperation with the vCE 4 and the VXLAN GW 5 has been described. This embodiment is effective for load distribution of the process, but this process may be carried out by another dedicated device or the entire process may be carried out by the VXLAN GW 5.

The instruction given from the management server to the communication device described in the present embodiment can be implemented, for example, using a technique such as Openflow (a registered trademark).

In the present embodiment, the example in which the tenant constantly selects a carrier line having a single communication condition has been described, but a different carrier line may be selected, for example, for each time zone. In this case, for example, a time zone field may be added to the connection management table 3142 illustrated in FIG. 7, and a single tenant may be connected to a carrier line having a different communication condition for each time zone, for each period, for each day of week, or the like.

Unlike the above description, the communication minimum range I which the separation is performed may be set as an application unit. In this case, for example, a setting may be performed so that a packet having a different VID for each application is transmitted, a setting of changing the VID in the access VLAN may be deleted in the vSW 3, and a setting of exchanging a VID may be performed for each application without being performed for each tenant. In this case, instead of a VID identifying a tenant set in the vSW3, a VID of an application is input in the VID field of the virtual network identifier illustrated in FIG. 7.

Further, the communication condition described in the present embodiment is the line quality (no delay or a best effort), redundancy of a line, occupation or sharing of a line, or the like but may be other conditions. For example, the DC service provider may make a contract with a plurality of carriers, and the carrier may be changed for each tenant.

While the above disclosure has been described using the exemplary embodiments, those skilled in the art will appreciate that various changes or modifications in form and detail may be made without departing from the spirit or the scope of the disclosed subject.

### REFERENCE SIGNS LIST

1 physical machine
2 virtual machine
3 virtual switch
4 virtual center edge
5 VXLAN: GW
6 center edge
7 provider edge
8 management server
9 UI generating server
30 CPU
31 memory
310 address table
311 identifier managing unit
312 line connecting unit
3121 vCE control unit
3122 VXLAN: GW control unit
313 information linking unit
3141 identifier management table
3142 connection management table
3143 line management table
3144 topology information
315 identifying unit
316 identifier assigning unit
317 VTEP
318 service provider UI generating unit
318 tenant UI generating unit
319 line management unit 318
32 input device
33 output device
34 communication device
Pn port

1. A data center linking system that connects a plurality of data centers via a communication network,
a plurality of lines having different communication conditions being set in the communication network, the data center linking system comprising:
a management server,
wherein each of the data centers includes a physical machine,
the physical machine includes a plurality of virtual machines respectively used by a plurality of tenants,
the management server
manages a designated communication condition when transmission and reception of a packet are performed via the line and a virtual network identifier of a first layer to be assigned to the packet in association with each other,
for each data center,
manages a virtual network identifier of a second layer for separating a packet of the tenant from packets of other tenants for the tenant using one virtual machine, and
manages the virtual network identifier of the first layer decided on the basis of the communication condition designated for the packet of the tenant and the virtual network identifier of the second layer decided for the packet of the tenant in association with each other,
when transmission and reception of a packet are performed between the plurality of data centers,
in a transmitting side data center,
a gateway device separates a packet separated on the basis of the virtual network identifier of the second layer by using the virtual network identifier of the first layer decided on the basis of the association of the transmitting side data center, and
an edge device transmits a packet to which the virtual network identifier of the first layer is assigned to the communication network.

2. The data center linking system according to claim 1,
wherein, in a receiving side data center,
an edge device receives the packet to which the virtual network identifier of the first layer is assigned from the communication network, and
a gateway device separates the packet separated using the virtual network identifier of the first layer using the virtual network identifier of the second layer decided on the basis of the virtual network identifier of the first layer in the receiving side data center, and transmits the separated packet to a virtual machine used by a tenant decided on the basis of the virtual network identifier of the second layer.

3. The data center linking system according to claim 1,
wherein, when a packet to be separated using the virtual network identifier of the second layer is separated using a virtual layer identifier of the third layer in the transmitting side data center,
the management server manages the virtual network identifier of the first layer decided on the basis of a combination of the virtual network identifier of the second layer and the virtual network identifier of the third layer in association with the combination for each data center, and
the gateway device of the transmitting side data center separates a packet separated on the basis of the virtual network identifier of the third layer and the virtual network identifier of the second layer using the virtual network identifier of the first layer decided on the basis of the association in the transmitting side data center.

4. The data center linking system according to claim 3,
wherein, in a receiving side data center,
an edge device receives the packet to which the virtual network identifier of the first layer is assigned from the communication network, and
a gateway device separates the packet separated using the virtual network identifier of the first layer using the virtual network identifier of the third layer and the virtual network identifier of the second layer decided on the basis of the association in the receiving side data center, and transmits the separated packet to a virtual machine used by a tenant decided on the basis of the virtual network identifier of the second layer.

5. The data center linking system according to claim 1,
wherein each of the data centers includes the management server.

6. The data center linking system according to claim 3,
wherein the virtual network identifier of the third layer is assigned for each type of communication, for each purpose of communication, or for each application in one tenant.

7. The data center linking system according to claim 1,
wherein the virtual network identifier of the first layer and the virtual network identifier of the third layer are VIDs of a VLAN, and the virtual network identifier of the second layer is a VNI of a VXLAN.

8. A data center linking method of connecting a plurality of data centers via a communication network in which a plurality of lines having different communication conditions are set, comprising:
managing a designated communication condition when transmission and reception of a packet are performed via the line and a virtual network identifier of a first layer to be assigned to the packet in association with each other;
managing a virtual network identifier of a second layer for separating a packet of the tenant from packets of other tenants for the tenant using one virtual machine;
managing the virtual network identifier of the first layer decided on the basis of the communication condition designated for the packet of the tenant and the virtual network identifier of the second layer decided for the packet of the tenant in association with each other;
in a transmitting side data center,
separating a packet separated on the basis of the virtual network identifier of the second layer by using the virtual network identifier of the first layer decided on the basis of the association of the transmitting side data center; and
transmitting a packet to which the virtual network identifier of the first layer is assigned to the communication network.

9. The data center linking method according to claim 8,
wherein, in a receiving side data center,
the packet to which the virtual network identifier of the first layer is assigned is received from the communication network,
the packet separated using the virtual network identifier of the first layer is separated using the virtual network identifier of the second layer decided on the basis of the virtual network identifier of the first layer in the receiving side data center, and
the separated packet is transmitted to a virtual machine used by a tenant decided on the basis of the virtual network identifier of the second layer.

10. The data center linking method according to claim 8,
wherein, when a packet to be separated using the virtual network identifier of the second layer is separated using a virtual layer identifier of the third layer, the virtual network identifier of the first layer decided on the basis of a combination of the virtual network identifier of the second layer and the virtual network identifier of the third layer is managed in association with the combination, and
in the transmitting side data center,
a packet separated on the basis of the virtual network identifier of the third layer and the virtual network identifier of the second layer is separated using the virtual network identifier of the first layer decided on the basis of the association in the transmitting side data center.

11. The data center linking method according to claim 10,
wherein, in a receiving side data center,
the packet to which the virtual network identifier of the first layer is assigned is received from the communication network,
the packet separated using the virtual network identifier of the first layer is separated using the virtual network identifier of the third layer and the virtual network identifier of the second layer decided on the basis of the association in the receiving side data center, and
the separated packet is transmitted to a virtual machine used by a tenant decided on the basis of the virtual network identifier of the second layer.

12. The data center linking method according to claim 10,
wherein the virtual network identifier of the third layer is assigned for each type of communication, for each purpose of communication, or for each application in one tenant.

13. The data center linking method according to claim 8,
wherein the virtual network identifier of the first layer and the virtual network identifier of the third layer are VIDs of a VLAN, and the virtual network identifier of the second layer is a VNI of a VXLAN.
